(19) United States
(12) Patent Application Publication
(10) Pub. No.: US 2017/0327233 A1
(43) Pub. Date: Nov. 16, 2017

(54) AVIONICS BAY

(71) Applicants: SAFRAN ELECTRICAL POWER, BLAGNAC CEDEX (FR); AIRBUS OPERATIONS, TOULOUSE (FR)

(72) Inventors: Philippe Pierre AVIGNON, BLAGNAC CEDEX (FR); Jean-Marc BLINEAU, BLAGNAC CEDEX (FR); Alexandre FLEURY, BLAGNAC CEDEX (FR); Francois GOGE, BLAGNAC CEDEX (FR); Philippe MAIRET, TOULOUSE (FR)

(21) Appl. No.: 15/524,245

(22) PCT Filed: Nov. 4, 2015
(86) PCT No.: PCT/FR2015/052976

§ 371 Date: May 3, 2017

(30) Foreign Application Priority Data
Nov. 4, 2014 (FR) 1460650

(51) Int. Cl. B64D 13/00; B64D 13/06

(52) U.S. Cl. CPC B64D 13/006; B64D 2013/0614; Y10S 62/05

(57) ABSTRACT

The invention concerns an avionics bay (1) for the installation of at least one electrical module (M), comprising a fluid cooling system and a housing (2) that is complementary to the electrical module (M) and that comprises an open front face (21) through which the module (M) can be removably installed inside said housing (2), and a rear face (20) on which there are arranged electrical connectors suitable for being connected to the electrical module (M), characterised in that the fluid cooling system comprises a cold plate (3) that is disposed on the rear face (20) of the housing (2) that is suitable for cooling the electrical module (M) when said electrical module (M) is installed inside the housing (2).

The present invention relates to an avionics bay receiving electrical modules for an aircraft, or more generally a aerial, space, maritime or terrestrial transport vehicle.

More precisely, it relates to the cooling system integrated into the avionics bay for cooling electrical modules which can for example be power electronics modules.

### GENERAL TECHNICAL FIELD AND PRIOR ART

Modern aircraft comprise more and more electrical system and therefore have to be equipped with electrical modules such as power electronics modules to ensure operation of the different electrical systems (for example electrical starting by an alternator/starter, air conditioning and pressurisation of the aircraft by means of electrical compressors suppressing engine air intakes, electrical de-icing of wings and the empennage in place of de-icing by air, electrical braking in place of hydraulic braking, electrical retraction/extension of landing gear, moving the aircraft on the ground by way of electrical engines housed in the wheels).

These electrical modules are removably installed in avionics bays inside the aircraft. More precisely, the electrical modules are plugged into housings complementary to said electrical modules, the avionics bay comprising several housings. These electrical modules are called Line Replaceable Unit (or LRU). In fact, these LRU modules are designed so they can be replaced individually during a maintenance operation by removing a defective module and installing in its place a new functional LRU module.

These LRU modules have strong thermal dissipation and cannot settle for conventional cooling devices via ventilation and air extraction. So it is known to link these LRU modules with fluid cooling devices for effectively cooling said LRU modules. Usually, these fluid cooling devices comprise a surface thermal exchanger (called “cold plate”) which is integrated into each of the LRU modules, and by a heat-transfer liquid tank and a device for cooling said fluid. So when said LRU modules are installed in the avionics bay, the cold plate is connected to the heat transfer liquid tank via a hydraulic connector with rapid connection/disconnection, such that when an LRU module is installed in the avionics bay it can be cooled by circulation of the heat-transfer liquid in the cold plate.

But such a solution has several difficulties. First, the service life of hydraulic connectors with rapid connection/disconnection is limited, and also there is a risk of leakage at the level of the hydraulic connectors with rapid connection/disconnection, which then involves a monitoring and maintenance operation of the hydraulic connectors with rapid connection/disconnection.

Also, such a solution poses problems during installation and disassembly of an LRU module in a housing of the avionics bay. In fact, LRU modules can be of considerable weight (over 25 kilograms), which makes them difficult to handle. So the connection with the cooling device is located on a lateral face of the LRU module, which means that the installation and disassembly of the LRU module is very precise so as not to damage the cooling device on the LRU module and on the bay.

### GENERAL PRESENTATION OF THE INVENTION

A general aim of the invention is to propose an avionics bay which facilitates maintenance operations on electrical modules and satisfactory ensures cooling of said electrical modules.

More particularly, according to one aspect the invention comprises an avionics bay for installation of at least one electrical module comprising a fluid cooling system and a housing which is complementary to the electrical module and which comprises an open front face through which the module can be removably installed inside said housing, and a rear face on which are arranged electrical connectors suitable for being connected to the electrical module, characterised in that the fluid cooling system comprises a cold plate which is arranged on the rear face of the housing, said cold plate being suitable for cooling the electrical module when said electrical module is installed inside the housing.

According to a particular characteristic, the avionics bay comprises at least one guide pin which is arranged on the rear face of the housing to guide displacement of the electrical module inside said housing.

According to an additional characteristic, the avionics bay comprises two guide pins.

According to an additional characteristic, the avionics bay comprises a damping stop arranged on the rear face of the housing such that the movement of the electrical module is attenuated when said electrical module reaches the rear face of the housing during installation of said electrical module inside said housing.

According to another characteristic, the avionics bay comprises a door which is arranged at the level of the front face of the housing to protect the electrical module when it is installed inside said housing.

According to a specific characteristic, the door comprises a pressure device for ensuring that the electrical module is pressed with sufficient contact pressure against the cold plate when said electrical module is installed inside the housing and the door is closed.

According to an additional characteristic, the avionics bay comprises an interposition material which is arranged so as to be located between said cold plate and the electrical module when said electrical module is installed inside the housing, so as to boost thermal exchanges between the electrical module and the cold plate.

According to another aspect, the invention relates to an electrical module characterised in that it is suitable for being installed and cooled in an avionics bay according to one of the characteristics cited earlier.

According to another aspect, the invention relates to an assembly comprising an electrical module installed in an avionics bay according to one of the characteristics cited earlier.

According to an additional aspect, the invention relates to an aircraft comprising an avionics bay according to one of the characteristics cited earlier.

### DESCRIPTION OF FIGURES

Other characteristics, aims and advantages of the present invention will emerge from the following detailed description and with reference to the appended drawings given by way of non-limiting examples and in which:

FIG. 1 illustrates a top plan view of an avionics bay according to a first embodiment;

FIG. 2 illustrates a frontal view of a housing of the bay according to the first embodiment;

FIG. 3 illustrates a side elevation of a housing according to the first embodiment in which a electrical module is installed;

FIG. 4 illustrates a rear view of a housing of the bay according to the first embodiment;

FIG. 5 is a legend of FIGS. 1 to 4;

FIGS. 6a, 6b and 6c, illustrate variants of a rear face of the housing of the avionics bay.

### DESCRIPTION OF ONE OR MORE EMBODIMENTS

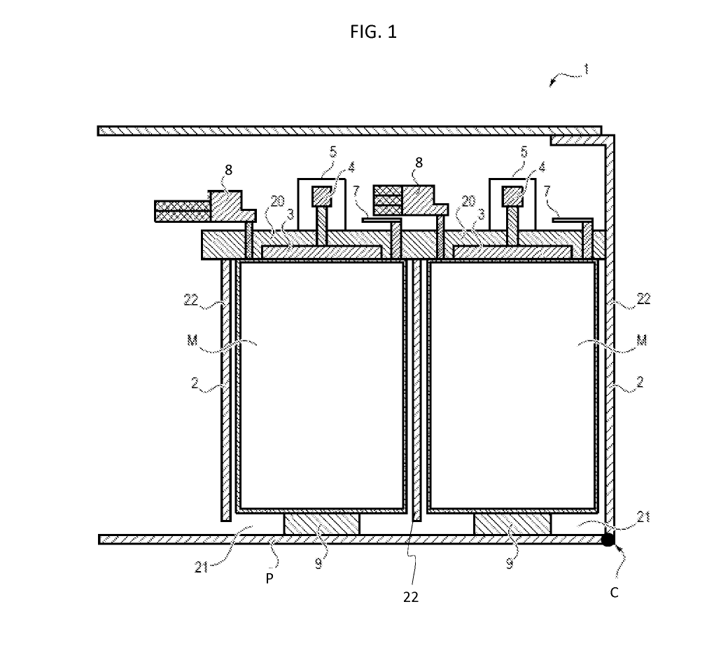

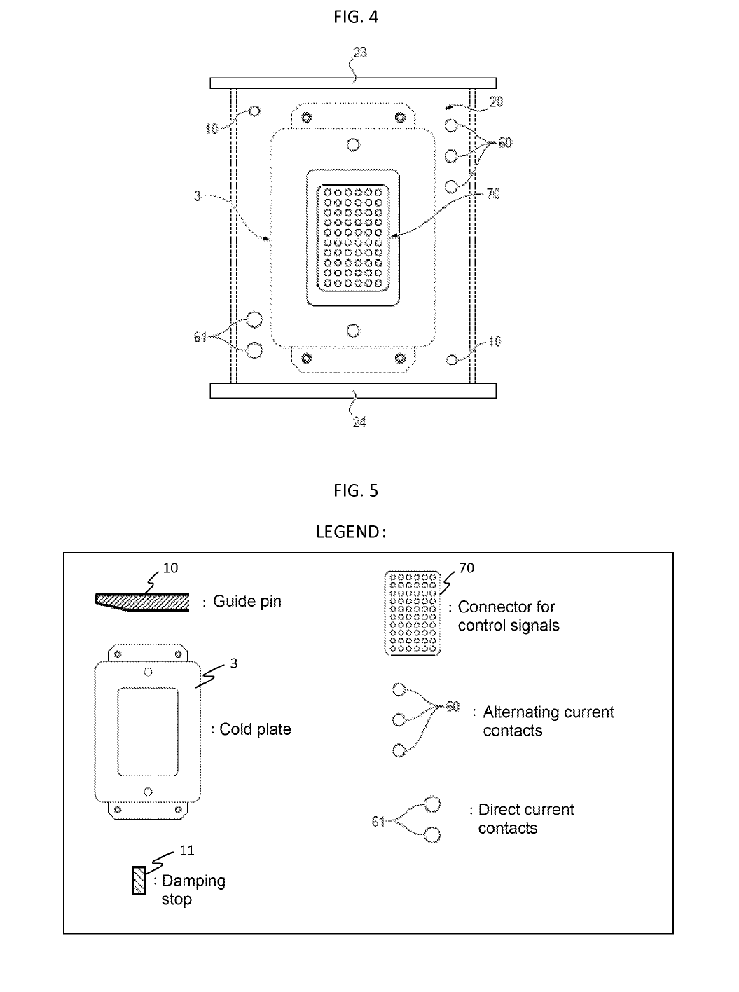

As shown in FIGS. 1 to 4, an avionics bay 1 comprises several housings 2 which each delimit a cavity such that it is possible to install an electrical module M inside each of the housings 2.

Each of the housings 2 is complementary in shape to the electrical module M it is to receive. In general the electrical modules M are parallelepiped rectangles. In this way, the housings 2 are also parallelepiped rectangles and comprise:
a rectangular rear face 20;
a rectangular front face 21 which is opened so that the modules M can be installed in the housings 2 via the front face 21;
two rectangular lateral faces 22;
a rectangular upper face 23;
a rectangular lower face 24.

To ensure electrical connection (a power supply and a data signal) of the electrical module M installed in a housing 2, electrical connectors are arranged on the rear face 20 of the housing 2 so as to be connected with complementary connectors arranged on the electrical module M when the latter is installed in the housing 2. These electrical connectors are connected to an electrical circuit arranged behind the rear face 20, said circuit electrical being composed of a bus bar 8 which sends the power supply and electrical wires 7 which send the data signal to the electrical module M.

More precisely, the electrical connectors arranged on the rear face 20 are:
three alternating current contacts 60 located on a peripheral part of the rear face 20 which are connected to the bus bar 8;
two direct current contacts 61 located on the peripheral part of the rear face 20 which are connected to the bus bar 8;
a connector for control signals 70 which is located in a central part of the rear face 20 and which is connected to the electrical wires 7.

With modern aircraft needing more and more electric power, electrical modules M (which are power electronics modules supplying various electrical equipment of aircraft) dissipate a large quantity of heat. So to cool the electrical modules M, a cold plate 3 is arranged on the central part of the rear face 20 of each housing 2. When an electrical module M is installed in a housing 2, it is in contact with a cold plate 3, and is cooled.

As shown in FIGS. 1 and 3, the cold plate 3 which is arranged on the rear face 20 is connected by hydraulic connectors 4 to a heat-transfer liquid tank and to a cooling system of said heat-transfer liquid (not shown).

The cold plates 3 are thermal surface exchangers inside which the heat-transfer liquid circulates. The heat-transfer liquid arrives cold in the cold plates 3, it is reheated by absorbing heat dissipated by the electrical modules M, and it is cooled by the cooling system arranged behind the avionics bay 1. The cooling system can be for example a dysphasic loop system.

The advantage of such an embodiment is that the hydraulic connectors 4 are connectors which ensure a fixed connection with the cold plate 3, without the drawback of rapid connection/disconnection, which both ensures better sealing between the hydraulic connectors 4 and the cold plate 3, and also limits maintenance of the fluid cooling system as the hydraulic connectors 4 have a longer service life.

Also, integrating the cold plates 3 into the bay is done such that they do not work structurally.

The cold plates 3 are arranged on the rear face 20 of the housings 2 to:
have the contact pressure cold plate 3/module M and the electrical contacts on a same axis
avoid friction with the lateral walls 22 of the module M during installation or dismounting of the electrical module M. Therefore, installation and dismounting of the electrical module M require no precise movement when the electrical module M is slid into the housing 2. This advantage is particularly significant as handling the electrical modules M can complicated by their considerable weight.

In the first embodiment, on each of the rear faces 20 of the housings 2, the cold plate 3 is arranged around the connector for control signals 70 so as to enclose said connector for control signals 70.

To improve cooling of the electrical modules M when they are installed in the housings 2, the electrical components which dissipate the most heat are preferably arranged behind the electrical modules M so as to be as close as possible to the cold plates 3. Simultaneously, the cold plates 3 are designed as a function of the thermal cartography of the module M.

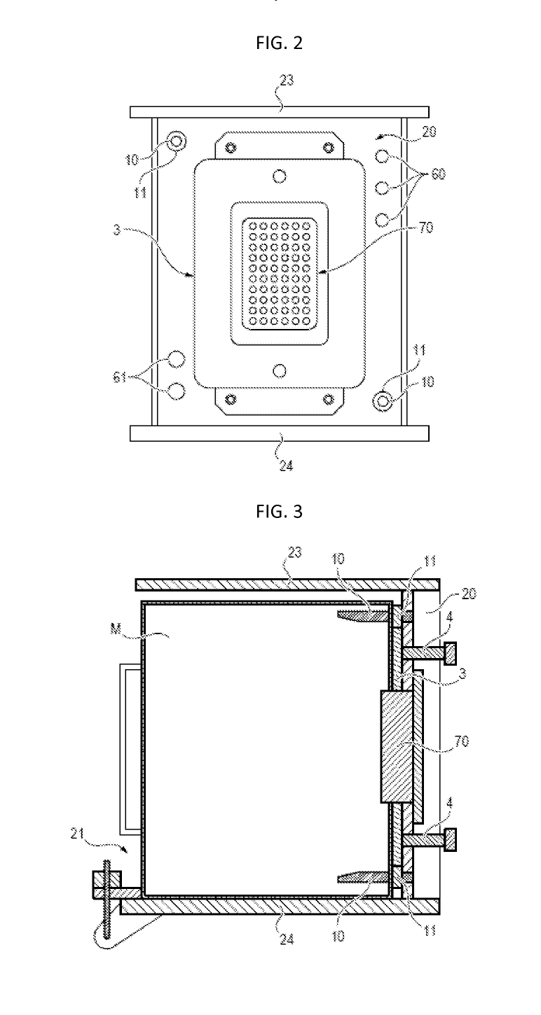

By way of advantage and as shown in FIGS. 2 to 4, the avionics bay 1 comprises two guide pins 10 which are arranged on the rear face 20 of each of the housings 2. These guide pins 10 comprise a rod which projects inside the cavity delimited by each of the housings 2. These guide pins 10 are intended to be introduced into complementary holes located behind the electrical modules M to guide displacement of the electrical modules M inside the housings 2. Such guiding ensures that the different electrical connectors located on the rear face 20 of the housings 2 are properly aligned with the complementary connectors arranged on the electrical modules M, and in this way ensures electrical connection of the electrical modules M to the electrical circuit of the aircraft.

The guide pins 10 preferably comprise an end which is directed towards the front face 21 of the housings 2 and which is bevelled such that even if the holes located on the electrical modules M are not perfectly aligned with the guide pins 10 during installation of the electrical modules M, the guide pins 10 can retract into said holes.

The number of guide pins 10 arranged on the rear face 20 is preferably two, but the avionics bay 1 can comprise only a single guide pin 10, or else more than two guide pins 10 (for example three).

The fact that the rear face 20 comprises two guide pins 10 blocks any rotation of the electrical module M, and allows sliding in the direction of the guide pins 10, and limits the surface of the rear face occupied by the guide pins 10, and permits tolerance in the positioning of the guide pins 10 and the holes on the electrical module.

In the embodiment presented in FIGS. 2 to 4, the guide pins 10 are located on the peripheral part of the rear face 20, on either side of the cold plate 3 in a diagonal of said rear face 20.

As shown in FIGS. 2 to 4, the avionics bay 1 comprises a damping stop 11 which is arranged on the rear face 20 of the housing 2 so as to damp movement of the electrical module M when it approaches the rear face 20 during installation of said electrical module M inside the housing 2.

Such a damping stop prevents the installation operation of the electrical module M from damaging the electrical connectors and the cold plate 3.

The damping stop 11 can comprise a spring, or else elastic material, for example rubber or equivalent.

In the embodiment presented in FIGS. 2 to 4, the bay 1 comprises two damping stops 11 which are each constituted by a ring made of elastic material threaded onto a guide pin 10.

The avionics bay 1 also comprises a door P, as shown in FIG. 1, which is arranged to the front of the avionics bay 1, at the level of the front faces 21 of the housings 2 comprising said avionics bay 1. This door P comprises a hinge C to let an operator open the door P during any maintenance operation, and close the door P when it is no longer necessary for it to be open so as to protect the electrical modules M which are installed in the housings 2.

The door P preferably comprises a pressure device 9 which ensures that the electrical module M is pressed with sufficient contact pressure against the cold plate 3 when said electrical module M is installed inside the housing 2 and the door P is closed.

The pressure device 9 comprises a spring or else elastic material which is arranged on a face of the door P which is directed towards the interior of the bay 1, towards the electrical module M when it is arranged in the housing 2. In this way, when the door P is closed the pressure device 9 leans on the electrical module M which is arranged in the housing 2, and presses it against the cold plate 3 to ensure proper cooling of the electrical module 2. The elasticity of the pressure device is adapted so that the contact pressure of the electrical module M against the cold plate 3 is not excessive so as not to deteriorate said cold plate 3.

According to a preferred embodiment interposition material, which has very high thermal conductivity according to the pressure axis, is arranged so as to be located between said cold plate 3 and the electrical module M when said electrical module M is installed inside the housing 2, so as to boost thermal exchanges between the electrical module M and the cold plate 3.

The interposition material is preferably used when contact pressure between the cold plate 3 and the electrical module M cannot be assured.

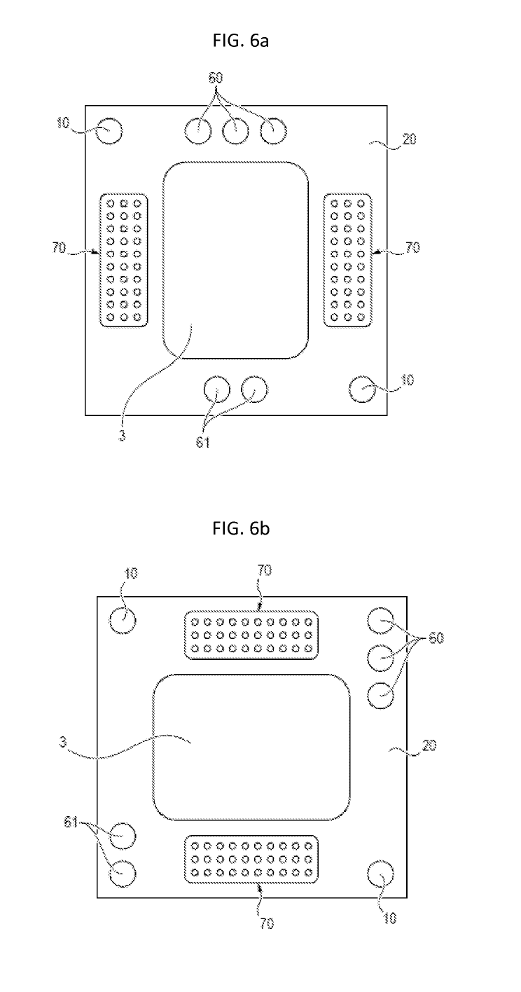

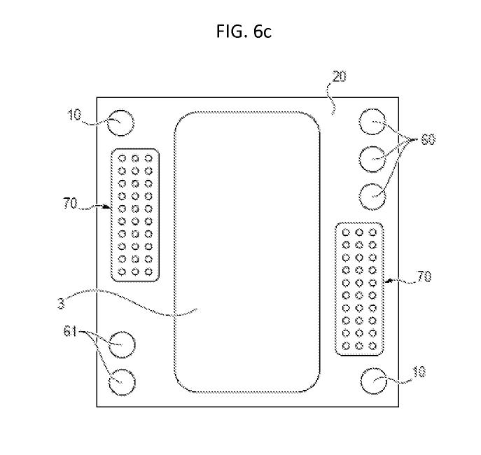

As shown in FIGS. 6a to 6c, several variants of a rear face 20 of the housing 2 are possible.

In fact, as shown in FIGS. 6a, 6b and 6c, the rear face 20 can comprise several connectors for control signals 70 which are located in the peripheral part of the rear face 20, on either side of the cold plate 3 which is located in the central part of said rear face 20.

The alternating current contacts 60 and the direct current contacts 61 can also be positioned according to several possible variants, FIGS. 6a to 6c being some examples of various possible variants.

1. An avionics bay for installation of at least one electrical module comprising a fluid cooling system and a housing which is complementary to the electrical module and which comprises an open front face through which the module can be removably installed inside said housing, and a rear face on which are arranged electrical connectors suitable for being connected to the electrical module, wherein the fluid cooling system comprises a cold plate which is arranged on the rear face of the housing, said cold plate being suitable for cooling the electrical module when said electrical module is installed inside the housing.

2. The avionics bay according to claim 1, comprising at least one guide pin which is arranged on the rear face of the housing to guide displacement of the electrical module inside said housing.

3. The avionics bay according to claim 2, comprising two guide pins.

4. The avionics bay according to claim 1, comprising a damping stop arranged on the rear face of the housing such that the movement of the electrical module is attenuated when said electrical module reaches the rear face of the housing during installation of said electrical module inside said housing.

5. The avionics bay according to claim 1, comprising a door which is arranged at the level of the front face of the housing to protect the electrical module when it is installed inside said housing.

6. The avionics bay according to claim 5, wherein the door comprises a pressure device for ensuring that the electrical module is pressed with a sufficient contact pressure against the cold plate when said electrical module is installed inside the housing and the door is closed.

7. The avionics bay according to claim 1, comprising an interposition material which is arranged so as to be located between said cold plate and the electrical module when said electrical module is installed inside the housing so as to boost thermal exchanges between the electrical module and the cold plate.

8. An electrical Module suitable for being installed and cooled in an avionics bay, according to claim 1.

9. An assembly comprising an electrical module installed in an avionics bay, according to claim 1.

10. An aircraft comprising an avionics bay according to claim 1.
